(19) United States
(12) Patent Application Publication
(10) Pub. No.: US 2010/0091070 A1
(43) Pub. Date: Apr. 15, 2010

(54) Circuit Board and Liquid Supplying Unit

(75) Inventor: Hitotoshi KIMURA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/573,493

(22) Filed: Oct. 5, 2009

(30) Foreign Application Priority Data
Oct. 9, 2008 (JP) 2008-262640
Aug. 31, 2009 (JP) 2009-199165

(51) Int. Cl. B41J 2/14

(52) U.S. Cl. 347/50

(57) ABSTRACT

There is provided a circuit board that is fixed to a liquid supplying unit installed to a liquid ejecting apparatus by being inserted into the liquid ejecting apparatus having a plurality of first apparatus-side terminals in a predetermined insertion direction. The circuit board includes a board main body that includes a first opening portion that is used for determining the position of the circuit board with respect to the liquid supplying unit, and a plurality of first top-face terminals, disposed on a first face of the board main body, that is brought into contact with at least a part of the plurality of first apparatus-side terminals and is arranged in the direction approximately perpendicular to the insertion direction when being installed to the liquid ejecting apparatus. The first opening portion is disposed on the rear side relative to the front ends of the plurality of first top-face terminals in the insertion direction and is disposed between a first terminal and a second terminal out of the plurality of first top-face terminals.

### BACKGROUND

1. Technical Field

The present invention relates to a circuit board and a liquid supplying unit, and more particularly, to a circuit board and a liquid supplying unit that are installed in a liquid ejecting apparatus.

2. Related Art

As liquid ejecting apparatuses, for example, ink jet printers are known. To the ink jet printers, ink is supplied, for example, from an ink cartridge that can be detachably attached to the ink jet printers. There are cases where a circuit board having an electrical device such as a memory for storing information relating to ink is installed in the ink cartridge. For example, a circuit board disclosed in JP-A-2002-198627 has an opening portion such as a notch or a hole, and the circuit board is fixed to the ink cartridge by the opening portion. In order to fix the circuit board to the ink cartridge, for example, a protruded portion disposed in the ink cartridge is inserted into the opening portion of the circuit board, and then the head portion of the protruded portion is fastened, whereby the circuit board can be fixed to the ink cartridge. In addition, when a plurality of the opening portions is disposed, there are cases where a fastening portion is disposed on some opening portions and the circuit board is fixed only by inserting the protruded portion into the other opening portions.

On the circuit board, which is disclosed in JP-A-2002-198627, fixed to the ink cartridge as described above, a plurality of terminals is disposed. These terminals are brought into contact with apparatus-side terminals included in the ink jet printer when the ink cartridge is inserted in a predetermined insertion direction so as to be installed to the ink jet printer. The circuit board described in JP-A-2002-198627 is fixed to the ink cartridge along the direction parallel to the insertion direction in which the ink cartridge is inserted into the ink jet printer. Thus, when the circuit board is inserted into the ink jet printer, the apparatus-side terminals of the ink jet printer slide on the circuit board.

In a case where the apparatus-side terminals slide on the circuit board at the time when the ink cartridge is inserted into the ink jet printer, there is a possibility that the apparatus-side terminals will be rubbed with the fastening portion formed on the opening portion or the opening portion. In such a case, the electrical contact between the apparatus-side terminals and the terminals disposed on the circuit board may be degraded due to depositions generated by the rubbing.

The related arts have also been disclosed in JP-A-2006-142484 and JP-A-2007-160588.

### SUMMARY

An advantage of some aspects of the invention is that it provides a circuit board and a liquid supplying unit that are capable of acquiring excellent contact between apparatus-side terminals and terminals disposed a circuit board for an ink cartridge of the type in which the apparatus-side terminals slide on the circuit board when being inserted into a liquid ejecting apparatus such as an ink jet printer.

The invention may be implemented in the following forms or applied examples.

### Applied Example 1

According to Applied Example 1, there is provided a circuit board that is fixed to a liquid supplying unit installed to a liquid ejecting apparatus by being inserted into the liquid ejecting apparatus having a plurality of first apparatus-side terminals in a predetermined insertion direction. The circuit board includes: a board main body that includes a first opening portion that is used for determining the position of the circuit board with respect to the liquid supplying unit; and a plurality of first top-face terminals, disposed on a first face of the board main body, that is brought into contact with at least a part of the plurality of first apparatus-side terminals and is arranged in the direction approximately perpendicular to the insertion direction when being installed to the liquid ejecting apparatus. The first opening portion is disposed on the rear side relative to the front ends of the plurality of first top-face terminals in the insertion direction and is disposed between a first terminal and a second terminal out of the plurality of first top-face terminals.

According to the above-described circuit board, the first opening portion is disposed between the first terminal and the second terminal out of the plurality of first top-face terminals. Accordingly, in a case where the apparatus-side terminals corresponding to the first top-face terminals slide on the circuit board at the time when the circuit board is inserted into a liquid ejecting apparatus, the passing of the apparatus-side terminals on the first opening portion disposed on the circuit board can be suppressed. As a result, the generation of deposits from the fastening portion formed on the first opening portion or the first opening portion due to rubbing can be suppressed. Accordingly, the first apparatus-side terminals and the first top-face terminals can be brought into electrical contact with each other sufficiently.

### Applied Example 2

The above-described circuit board according to Applied Example 1 wherein the liquid ejecting apparatus further includes: a second top-face terminal, disposed on the first face of the board main body, that is brought into contact with a second apparatus-side terminal when being installed to the liquid ejecting apparatus. The liquid ejecting apparatus further includes the second apparatus-side terminal that is disposed in a position different from those of the plurality of first apparatus-side terminals in the insertion direction, and the second top-face terminal is disposed in an area other than an area through which the first opening portion passes in a case where the first opening portion is assumed to be moved parallel in a direction opposite to the insertion direction.

In such a configuration, it can be suppressed that the apparatus-side terminals pass on the first opening portion in a case where the first and second apparatus-side terminals slide on the circuit board at the time when the circuit board is inserted into the liquid ejecting apparatus. As a result, the generation of deposits from the fastening portion formed on the first opening portion or the first opening portion due to rubbing can be suppressed. Accordingly, the first and second apparatus-side terminals and the first and second top-face terminals can be brought into electrical contact with each other sufficiently.

### Applied Example 3

In the above-described circuit board according to Applied Example 1 or 2, the first opening portion is disposed between the front ends and the rear ends of the plurality of first top-face terminals in the insertion direction.

In such a configuration, the first opening portion is disposed between both ends of the first top-face terminals in the insertion direction. As a result, the positions of the first top-face terminals in the liquid supplying unit can be determined with high precision. Accordingly, the first top-face terminals and the first apparatus-side terminals can be sufficiently brought into contact with each other.

### Applied Example 4

In the above-described circuit board according to any one of Applied Example 1 to 3, the board main body further includes a second opening portion that is used for determining the position of the circuit board with respect to the liquid supplying unit, and the second opening portion is disposed on the rear side relative to the rear ends of the plurality of top-face terminals in the insertion direction.

In such a configuration, the second opening portion is included on a side opposite to the insertion direction side, in addition to the first opening portion. Accordingly, it is possible to determine the position of the circuit board in the liquid supplying unit more reliably.

### Applied Example 5

In the above-described circuit board according to any one of Applied Example 1 to 4, the first terminal and the second terminal are the two terminals, which are closest to the center of the width of the circuit board in the direction perpendicular to the insertion direction, out of the plurality of first top-face terminals.

In such a configuration, the first opening portion is located near the center of the circuit board in the direction perpendicular to the insertion direction. Accordingly, it is possible to determine the position of the circuit board in the liquid supplying unit in a stable manner.

### Applied Example 6

The above-described circuit board according to any one of Applied Example 1 to 5 further includes: a first rear-face terminal and a second rear-face terminal that are disposed on the second face of the board main body and are electrically connected to a plurality of unit terminals included in the liquid supplying unit. The first opening portion is disposed between the first rear-face terminal and the second rear-face terminal.

In such a configuration, the first opening portion is disposed between the first rear-face terminal and the second rear-face terminal. Accordingly, the positions of the first rear-face terminal and the second rear-face terminal in the liquid supplying unit can be determined with high precision.

### Applied Example 7

According to Applied Example 7, there is provided a circuit board that is fixed to a liquid supplying unit installed to a liquid ejecting apparatus by being inserted into the liquid ejecting apparatus having a plurality of apparatus-side terminals in a predetermined insertion direction. The circuit board includes: a board main body that includes a first opening portion that is used for determining the position of the circuit board with respect to the liquid supplying unit; and a plurality of top-face terminals, disposed on a first face of the board main body, that is brought into contact with at least a part of the plurality of apparatus-side terminals when being installed to the liquid ejecting apparatus. The first opening portion is disposed on the insertion direction side relative to the rear ends of the plurality of top-face terminals in the insertion direction and is disposed in an area other than an area through which the plurality of top-face terminals passes in a case where the plurality of top-face terminals is assumed to be moved parallel in the insertion direction. Also in such a configuration, apparatus-side terminals and the top-face terminals can be brought into electrical contact with each other sufficiently.

### Applied Example 8

According to Applied Example 8, there is provided a circuit board that is fixed to a liquid supplying unit installed to a liquid ejecting apparatus by being inserted into the liquid ejecting apparatus having a plurality of apparatus-side terminals in a predetermined insertion direction. The circuit board includes: a board main body that includes a first opening portion that is used for determining the position of the circuit board with respect to the liquid supplying unit; and a plurality of top-face terminals, disposed on a first face of the board main body, that is brought into contact with at least a part of the plurality of apparatus-side terminals when being installed to the liquid ejecting apparatus. The pitches of adjacent apparatus-side terminals, out of the plurality of apparatus-side terminals, measured in the direction perpendicular to the insertion direction include a first pitch and a second pitch that is wider than the first pitch, and the first opening portion is disposed between two straight lines that are acquired by extending the loci of two of the apparatus-side terminals disposed at the second pitch on the board main body when the board main body is installed to the liquid ejecting apparatus. Also in such a configuration, contact between the apparatus-side terminals and the top-face terminals can be electrically brought into contact with each other sufficiently. In addition, the above-described second pitch may be configured to be a pitch that is N times the first pitch (where N is an integer equal to or larger than two).

Furthermore, the invention may be implemented in various forms. Thus, the invention may be implemented in various forms such as a liquid supplying unit having a circuit board, a liquid container having a circuit board, or an ink cartridge having a circuit board.

### BRIEF DESCRIPTION OF THE DRAWINGS

The invention will be described with reference to the accompanying drawings, wherein like numbers reference like elements.

FIG. 1 is a schematic explanatory diagram showing the configuration of a printing system according to an example of the invention.

FIG. 2 is an exploded perspective view schematically showing the configuration of an ink cartridge.

FIG. 3 is an enlarged exploded perspective view of the front face side of the ink cartridge.

FIGS. 4A, 4B, and 4C are diagrams showing the configuration of a circuit board.

FIG. 5 is a first diagram showing the appearance of the installation of the ink cartridge to a carriage.

FIG. 6 is a second diagram showing the appearance of the installation of the ink cartridge to a carriage.

FIGS. 7A and 7B are explanatory diagrams showing the configuration of a contact mechanism.

FIG. 8 is a diagram showing the appearance of sliding apparatus-side terminals at the time of insertion thereof.

FIG. 9 is a diagram showing the configuration of the top face of a circuit board according to a first modified example.

FIG. 10 is a diagram showing the configuration of the top face of a circuit board according to a second modified example.

### DESCRIPTION OF EXEMPLARY EMBODIMENTS

Next, embodiments of the invention will be described based on examples with reference to the accompanying drawings.

### Example

### Configuration of Printing System

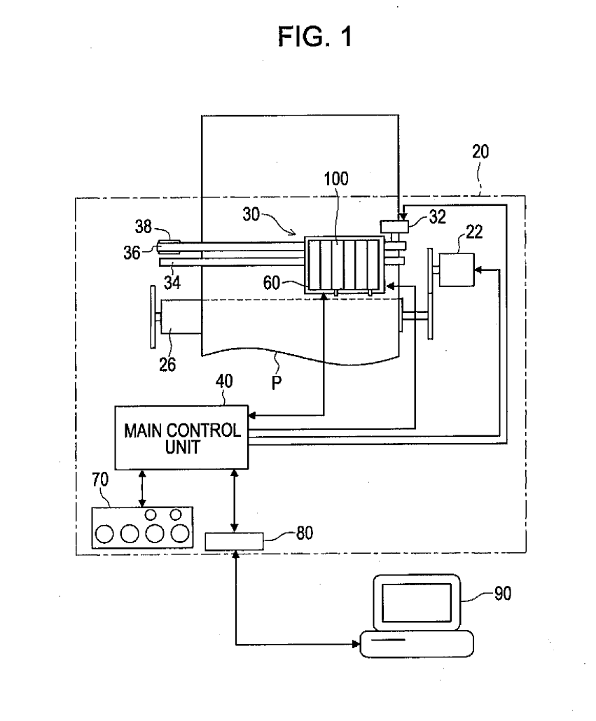

Hereinafter, an embodiment of the invention will be described based on an example. FIG. 1 is a schematic explanatory diagram showing the configuration of a printing system according to the example. The printing system includes a printer 20, a computer 90, and an ink cartridge 100. The printer 20 is connected to the computer 90 through a connector 80.

The printer 20 includes a sub-scanning transport mechanism, a main scanning transport mechanism, a head driving mechanism, and a main control unit 40 that is used for controlling each mechanism. The sub-scanning transport mechanism includes a paper feed motor 22 and a platen 26. The sub-scanning transport mechanism transports a paper sheet P in the sub-scanning direction by transferring the rotation of the paper feed motor to the platen. The main scanning transport mechanism includes a carriage motor 32, a pulley 38, a driving belt 36 that is stretched between the carriage motor 32 and the pulley 38, and a slide shaft 34 that is disposed to be parallel to the axis of the platen 26. The slide shaft 34 holds the carriage 30, which is fixed to the driving belt 36, so as to enable it to slide. The rotation of the carriage motor 32 is transferred to the carriage 30 though the driving belt 36, and the carriage 30 reciprocates along the slide shaft 34 in the axis direction (main scanning direction) of the platen 26. The head driving mechanism includes a print head unit 60 that is mounted on the carriage 30 and ejects ink on a paper sheet P by driving the print head. To the print head unit 60, a plurality of ink cartridges can be installed so as to be detachably attached, as described later. In addition, the printer 20 further includes an operation unit 70 that is used by a user for performing various settings of the printer or checking the status of the printer.

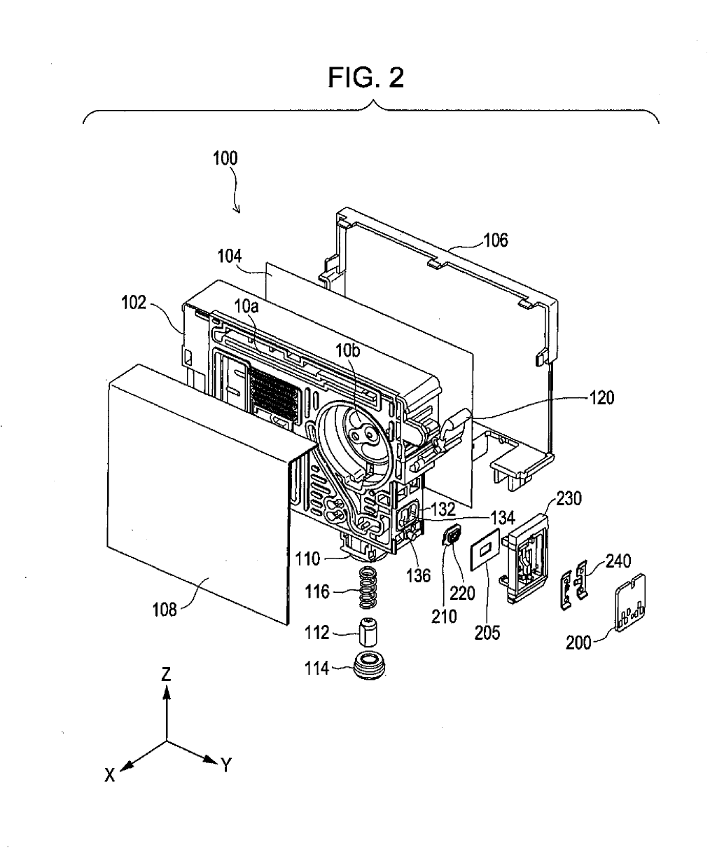

FIG. 2 is an exploded perspective view schematically showing the configuration of the ink cartridge 100. The vertical direction of the ink cartridge 100 in a state of being installed to the carriage 30 coincides with the direction of the Z axis shown in FIG. 2.

The ink cartridge 100 serving as a liquid supplying unit includes a container main body 102, a first film 104, a second film 108, and a cover 106. These members, for example, are formed of resins that can be thermally welded together. On the lower face of the contained main body 102, a liquid supplying portion 110 is formed. Inside the liquid supplying portion 110, a sealing member 114, a spring member 112, and a locking spring 116 are sequentially housed from the lower face side. The sealing member 114 seals the inner wall of the liquid supplying portion 110 and the outer wall of an ink supplying needle (to be described later) so as not to generate any gap therebetween at a time when the ink supplying needle of the print head unit 60 is inserted into the liquid supplying portion 110. The spring member 112 is brought into contact with the inner wall of the sealing member 114 so as to close the liquid supplying portion 110 at a time when the ink cartridge 100 is not installed to the print head unit 60. The locking spring 116 biases the spring member 112 in a direction for being brought into contact with the inner wall of the sealing member 114. When the ink supplying needle is inserted into the liquid supplying portion 110, the upper end of the ink supplying needle lifts the spring member 112 upward. Accordingly, a gap is generated between the spring member 112 and the sealing member 114, and ink is supplied from the gap to the ink supplying needle.

On the top face (a face positioned on the positive direction side of the X axis), the rear face (a face positioned on the negative direction side of the X axis), and the front face (a face positioned on the positive direction side of the Y axis) of the container main body 102, a flow path forming portion having the shape of a start of a rib 10a is formed. The first film 104 and the second film 108 are attached to the container main body 102 so as to cover the entire top face and the entire rear face of the container main body 102. The first film 104 and the second film 108 are precisely attached so as to prevent the generation of any gap from the cross-sections of the flow path forming portion that is formed in the container main body 102. Inside the ink cartridge 100, a liquid flowing path such as a plurality of small chambers and fine flowing paths are partitioned so as to be formed by the flow path forming portion, the first film 104, and the second film 108. In addition, between a valve housing portion 10b that is formed in the container main body 102 as a part of the flow forming portion and the second film 108, a negative-pressure generating valve is disposed, which is not shown in the figure for simplification of the drawing. The cover 106 is attached to the rear face side of the container main body 102 so as to cover the first film 104.

The liquid flowing path that is formed in the ink cartridge 100 has one end communicating with the atmosphere and the other end communicating with the liquid supplying portion 110. In other words, the ink cartridge 100 is an atmosphere-communication-type ink cartridge 100 in which the atmosphere is introduced into the liquid flowing path depending on whether ink is supplied to the printer 20. A detailed configuration of the liquid flowing path will not be described here.

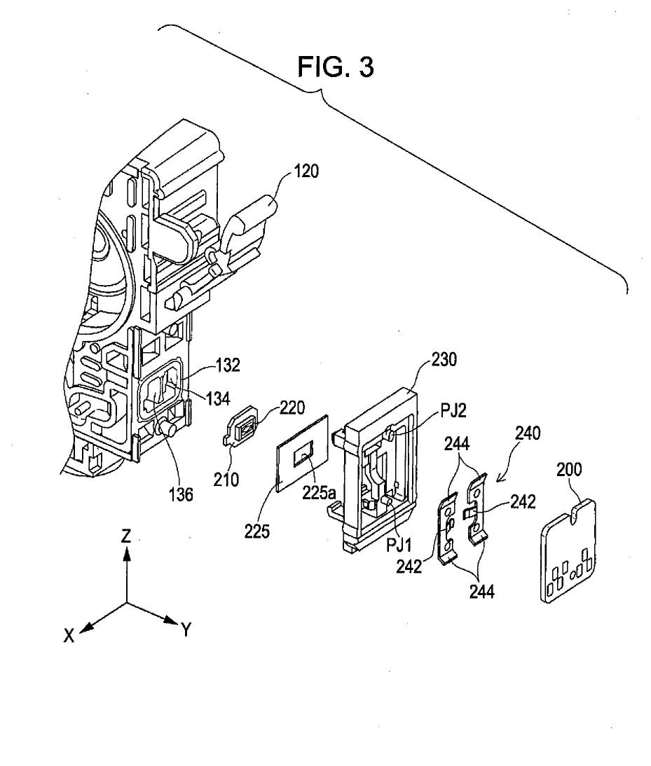

FIG. 3 is an enlarged exploded perspective view of the front face side of the ink cartridge 100. On the front face of the container main body 102, a lever 120 that is engaged with the side of a holder mounted in the print head unit 60 is mounted. For example, in a position below the lever 120, a base member housing portion 134 as a part of the flow path forming portion is opened. Around the opening of the base member housing portion 134, a welding rib 132 is formed. In the base member housing portion 134, a partition wall 136 that divides the liquid flowing path formed by the base member housing portion 134 into an upstream-side flow path and a downstream-side flow path is formed.

Near the base member housing portion 134 of the container main body 102, a sensor base member 210, a sensor chip 220, a welding film 225, a cover 230, a relay terminal 240, and a circuit board 200 are mounted in the above mentioned order.

The welding film 225 allows the sensor base member 210 to be held in the opening portion of the base member housing portion 134 and precisely seals the base member housing portion 134 as a liquid flowing path. The welding film 225 is welded to the welding rib 132 together with being bonded to the outer peripheral portion of the sensor base member 210. The cover 230 is disposed so as to press the sensor chip 220 and the welding film 225. A relay terminal 240 is housed in the cover 230. In addition, the relay terminal 240 has a terminal 242 that is electrically connected to the electrode terminal (not shown) of the sensor chip 220 through a hole 225a formed in the welding film 225. The circuit board 200 is mounted in the cover 230 and is electrically connected to a terminal 244 of the relay terminal 240 through a rear face terminal to be described later.

The sensor chip 220, although not shown in the figure, includes a vibration plate that covers the opening of the base member housing portion 134 and a piezoelectric element that is disposed on the vibration plate. When the ink cartridge 100 is installed in the printer 20, the terminal of the piezoelectric element is electrically connected to the printer 20 through the above-described terminal 242 and a terminal disposed on the sensor tip 220 to be described later. The printer 20 can vibrate the vibration plate through the piezoelectric element by providing the piezoelectric element with electrical energy. Thereafter, the printer 20 can detect the existence of ink in the base member housing portion 134 by detecting the characteristics (the frequency or the like) of the residual vibration of the vibration plate though the piezoelectric element. In particular, when the internal state of the base member housing portion 134 changes from the state of being filled with ink to the state of being filled with air due to the exhaustion of the ink stored in the ink cartridge 100, the characteristics of the residual vibration of the vibration plate are changed. By detecting such a change in the vibration characteristics through the piezoelectric element, the ink jet printer can detect the existence of ink in the base member housing portion 134.

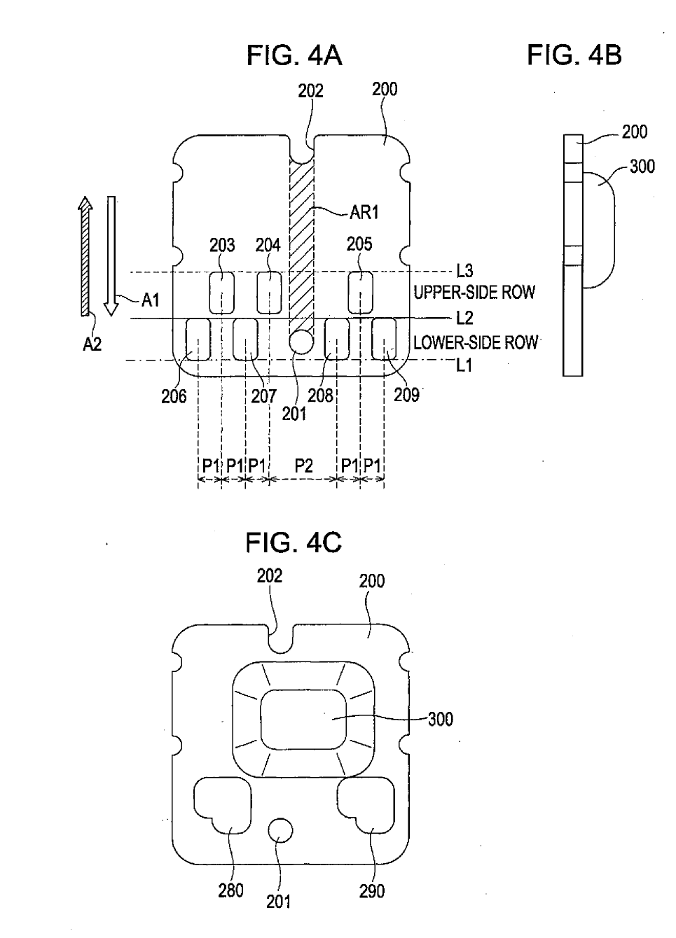

FIG. 4A shows the configuration of the top face of the circuit board 200. The top face is a face that is exposed outward when the circuit board 200 is installed to the ink cartridge 100. FIG. 4B shows a diagram of the circuit board 200 viewed from the side. FIG. 4C shows the configuration of the rear face of the circuit board 200. The rear face is a face that faces the ink cartridge 100 side when the circuit board 200 is installed to the ink cartridge 100. In the lower end portion of the circuit board 200, a position determining hole 201 as a first opening portion is formed. In addition, in the upper end portion of the circuit board 200, a position determining groove 202 as a second opening portion is formed. The positions of the position determining hole 201 and the position determining groove 202 on the circuit board 200 in the horizontal direction (the X-axis direction) are almost the same. In other words, the position determining hole 201 and the position determining groove 202 are disposed so as to be aligned in the same Z axis. As shown in FIG. 3, when the circuit board 200 is installed to the concave portion of the cover 230, a first protruded portion PJ1 formed on the cover 230 is fitted into the position determining hole 201, and a second protruded portion PJ2 formed on the cover 230 is fitted into the position determining groove 202. The front end portions of the first and second protruded portions PJ1 and PJ2 are caught and fastened. Accordingly, the circuit board 200 is fixed to the cover 230. In this example, both the front end portions of the first and second protruded portions PJ1 and PJ2 are fastened. However, either one of them may be configured to be fastened.

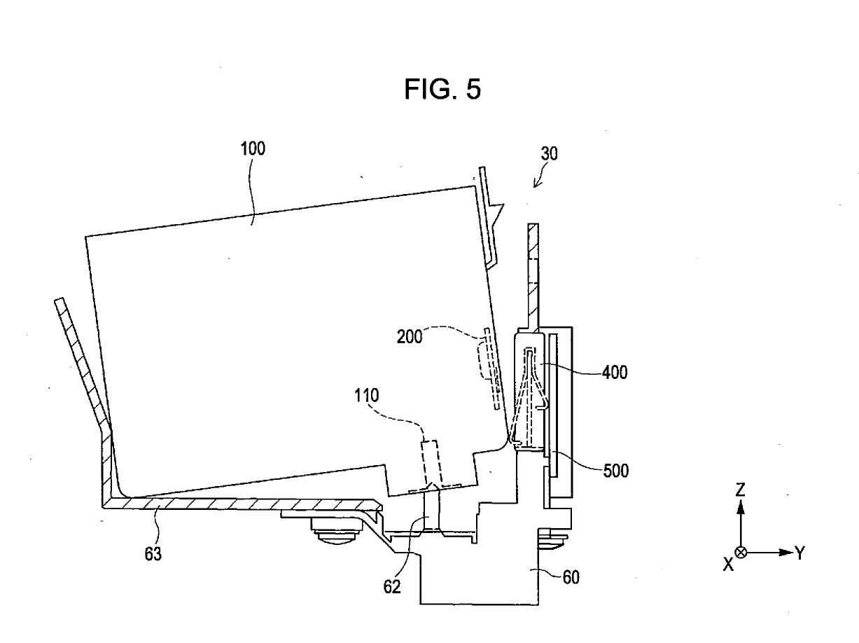

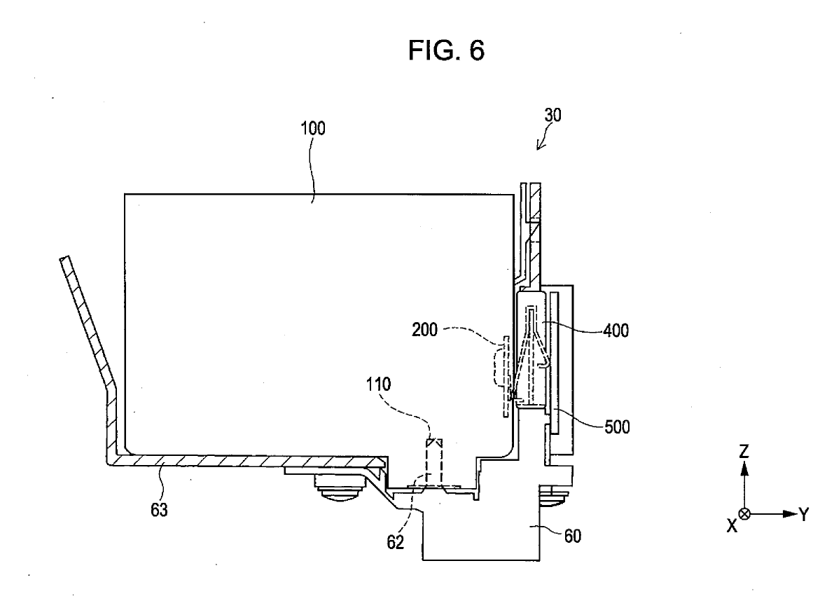

Hereinafter, the appearance of installing the ink cartridge 100 to the carriage 30 will be described with reference to FIGS. 5 and 6. As shown in FIG. 5, the carriage 30 includes a print head unit 60, an ink supplying needle, 62 and a holder 63. The ink supplying needle 62 is disposed on the top face of the print head unit 60. The holder 63 is fixed above the print head unit 60. By inserting the ink cartridge 100 into the lower portion (the negative direction of the Z axis in FIG. 5) of the holder 63, the ink cartridge 100 is completely installed to the holder 63. When the ink cartridge 100 is completely installed to the holder 63, the ink supplying needle 62 is inserted into the liquid supplying portion 110. Accordingly, the ink housed in the ink cartridge 100 is supplied to the print head unit 60 through the ink supplying needle 62. As can be understood from the description above, the ink cartridge 100 is installed to the holder 63 by being inserted into the holder 63 so as to move in the negative direction of the Z axis in FIGS. 5 and 6. The negative direction of the Z axis in FIGS. 5 and 6 is also referred to as the direction of insertion of the ink cartridge 100.

Now, the circuit board 200 will be described further with reference back to FIGS. 4A to 4C. In FIG. 4A, arrow A1 denotes the insertion direction of the above-described ink cartridge 100, and arrow A2 denotes the direction opposite to the insertion direction. As shown in FIGS. 4A to 4C, the circuit board 200 includes a memory device 300 on the rear face thereof and includes a terminal group that is configured by seven top-face terminals 203 to 209 on the top face thereof. The memory device 300 stores information on the ink, which is housed in the ink cartridge 100, therein. The top-face terminals 203 to 209 are formed in an approximately rectangular shape and are disposed to form two rows that are approximately perpendicular to the insertion direction A1. Of the two rows, a row that is located on the insertion direction A1 side, that is, a row located on the lower side in FIG. 4A is referred to as a lower-side row, and a row located on a side of the direction A2 opposite to the insertion direction, that is, a row located on the upper side in FIG. 4A is referred to as an upper-side row. The top-face terminals that are arranged so as to form the upper-side row are a ground terminal 203, a power source terminal 204, and a reset terminal 205, which are sequentially arranged from the left side in FIG. 4A. In addition, the top-face terminals that are arranged so as to form the lower-side row are a first sensor driving terminal 206, a clock terminal 207, a data terminal 208, and a second sensor driving terminal 209, which are sequentially arranged from the left side in FIG. 4A. These top-face terminals 203 to 209 are disposed in positions to be brought into contact with corresponding apparatus-side terminals (to be described in detail later) that are installed on the printer 20 side. In addition, the “insertion direction A1 side” represents the front end side of the circuit board 200 in the direction in which the circuit board 200 moves in a case where the circuit board 200 is inserted into the holder 63 (see FIGS. 5 and 6).

The top-face terminals 203 to 205 that form the upper-side row and the top-face terminals 206 to 209 that form the lower-side row are disposed to be deviated from each other such that the centers of the top-face terminals 203 to 205 and the centers of the top-face terminals 206 to 209 are not aligned to be parallel to the insertion direction A1 so as to configure the disposition of a so-called zigzag pattern. The top-face terminals 203 to 209 that are deviated from each other so as to be adjacently located are disposed at a first pitch P1 or a second pitch P2 that is wider than the first pitch P1 in the direction perpendicular to the insertion direction A1. While the top-face terminal 204 and the top-face terminal 208 are disposed at the second pitch P2, the other top-face terminals are disposed at the first pitch P1. Between the top-face terminal 204 and the top-face terminal 208 that are disposed at the second pitch P2, in particular, between a Z axis through which the top-face terminal 204 passes and a Z axis through which the top-face terminal 208 passes, a position determining hole 201 is formed. The diameter of the position determining hole 201, for example, is formed to be almost equal to or smaller than the first pitch P1. The first pitch P1 and the second pitch P2 are set in accordance with the pitch of apparatus-side terminals (to be described later) of the printer 20 side that are brought into contact with the top-face terminals 203 to 209. The first pitch P1 and the second pitch P2 will be described in detail later.

The ground terminal 203, the power source terminal 204, the reset terminal 205, the clock terminal 207, and the data terminal 208 out of the top-face terminals 203 to 209 are connected to the memory device 300 through internal wirings (not shown) of the circuit board 200 and are used for the printer 20 to access the memory device 300.

The position determining hole 201 is arranged between the clock terminal 207 and the data terminal 208 out of the top-face terminals 206 to 209 that form the lower-side row. The position determining hole 201 is arranged on the side of the direction A2 opposite to the insertion direction relative to horizontal line L1 denoted by a dashed-dotted line shown in FIG. 4A, that is, the side of the direction A2 opposite to the insertion direction relative to the end portions of the top-face terminals 206 to 209, which form the lower-side row, located on the insertion direction A1 side. In description here, the end portion located on the insertion direction A1 side is also referred to as a front end, and the end portion located on the side of the direction A2 opposite to the insertion direction is also referred to as a rear end. In addition, the position determining hole 201 is arranged on the insertion direction A1 side relative to horizontal line L2 denoted by a solid line shown in FIG. 4A, that is, on the side of the insertion direction A1 relative to the end portions of the top-face terminals 206 to 209, which form the lower-side row, located on the side of the direction A2 opposite to the insertion direction. Moreover, the position determining hole 201 is arranged on the insertion direction A1 side relative to horizontal line L3 denoted by a broken line shown in FIG. 4A, that is, on the insertion direction A1 side relative to the end portions of the top-face terminals 203 to 205, which form the upper-side row, located on the side of the direction A2 opposite to the insertion direction. In addition, in an area AR1 through which the position determining hole 201 passes in a case where the position determining hole 201 is assumed to be moved parallel to the side of the direction A2 opposite to the insertion direction, no top-face terminal is disposed. In other words, the position determining hole 201 is arranged in an area other than the area through which the top-face terminals 203 to 209 pass in a case where the top-face terminals 203 to 209 are assumed to be moved parallel to the insertion direction A1. Here, the horizontal lines L1, L2, and L3 shown in FIG. 4A are lines that are perpendicular to the insertion direction A1.

As shown in FIG. 4C, on the rear face of the circuit board 200, a first rear-face terminal 280 and a second rear-face terminal 290 are disposed in addition to the above-described memory device 300. The first rear-face terminal 280 is electrically connected to the second sensor driving terminal 209 located on the top face through an internal wiring (not shown) of the circuit board 200. In addition, the second rear-face terminal 290 is electrically connected to the first sensor driving terminal 206 located on the top face through an internal wiring (not shown) of the circuit board 200. The first rear-face terminal 280 and the second rear-face terminal 290 are electrically connected to the sensor chip 220 through the terminal 244 of the above-described relay terminal 240. As a result, the printer 20 can access the sensor chip 220 through the first sensor driving terminal 206 and the second sensor driving terminal 209. As shown in FIG. 4C, the position determining hole 201 is arranged between the first rear-face terminal 280 and the second rear-face terminal 290.

When the ink cartridge 100 is completely installed to the holder 63 as shown in FIG. 6, the top-face terminals 203 and 209 of the circuit board 200 are electrically connected to a carriage circuit 500 through a contact mechanism 400 that is included in the holder 63. The carriage circuit 500 includes logic circuits that access the memory device 300 of the ink cartridge 100 and the sensor chip 220 in cooperation with the main control unit 40.

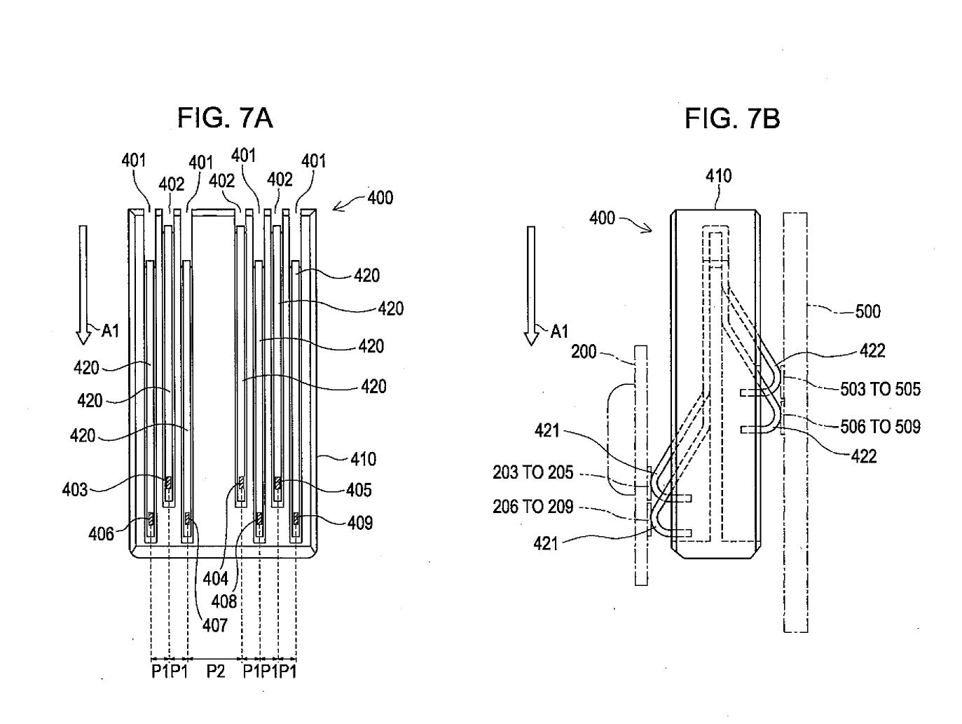

FIGS. 7A and 7B are explanatory diagrams showing the configuration of the contact mechanism 400. The contact mechanism 400 includes a main body portion 410 and a plurality of (in this example, seven) contact forming members 420. In the main body portion 410, a plurality of slits 401 and 402 of two types having different depths in the insertion direction A1 is alternately formed in accordance with the upper-side row and the lower-side row of the top-face terminals 203 to 209 of the circuit board 200. In each of the slits 401 and 402, a contact forming member 420, which is made of metal, having conductivity and elasticity is inserted. The contact forming member 420 is formed to have two end portions 421 and 422 formed in a curved shape and a portion near the center portion bent so as to pass across the top and rear faces of the main body portion 410 through the slits 401 and 402, by performing a bending process for one metallic bar.

Of both end portions of the contact forming member 420, an end portion 421 that is exposed to the inner side of the holder 63, that is, the circuit board 200 side is elastically brought into contact with corresponding top-face terminals out of the top-face terminals 203 to 209 of the circuit board 200. On the other hand, of both the end portions of the contact forming member 420, an end portion 422 that is exposed to the outer side of the holder 63, that is, the carriage circuit 500 side is elastically brought into contact with corresponding terminals out of the terminals 503 to 509 installed to the carriage circuit 500.

In FIG. 7A, contact points 403 to 409 of the contact forming member 420 that are brought into contact with the top-face terminals 203 to 209 disposed on the circuit board 200 are shown. Such contact points 403 to 409 serve as apparatus-side terminals that are used for electrically connecting the printer 20 and the top-face terminals 203 to 209 disposed on the circuit board 200. Hereinafter, the contact points 403 to 409 shown in FIG. 7A are referred to as apparatus-side terminals 403 to 409. When the ink cartridge 100 is installed to the holder 63, the apparatus-side terminals 403 to 409 are brought into contact with the above-described top-face terminals 203 to 209.

The apparatus-side terminals 403 to 409 that are located adjacent to each other are disposed at a first pitch P1 or a second pitch P2, which is wider than the first pitch P1, in the direction perpendicular to the insertion direction A1. In particular, a apparatus-side terminal 406, a apparatus-side terminal 403, and a apparatus-side terminal 407 are sequentially disposed from the left side in FIG. 7A at the first pitch P1. In addition, a apparatus-side terminal 407 and a apparatus-side terminal 404 are disposed at the second pitch P2. A apparatus-side terminal 404, a apparatus-side terminal 408, a apparatus-side terminal 405, and a apparatus-side terminal 409 are disposed at the first pitch P1. In addition, it is preferable that the second pitch P2 is a pitch that is N times (here, N is an integer equal to or larger than two) the first pitch P1. In this example, the second pitch P2 is a pitch that is three times the first pitch P1. The position determining hole 201 (FIG. 4) arranged on the circuit board 200 is positioned between two straight lines that are acquired by extending the loci of the apparatus-side terminal 407 and the apparatus-side terminal 404, which are disposed at the second pitch P2, for a case where the apparatus-side terminals 407 and 404 slide on the circuit board 200.

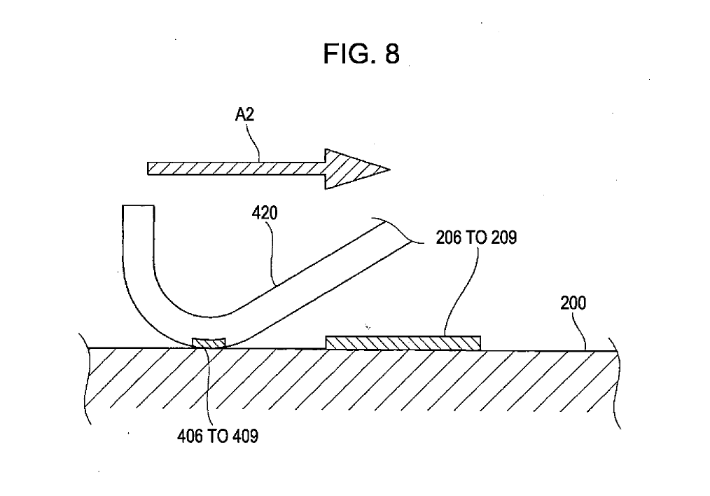

FIG. 8 is a diagram showing the sliding of the apparatus-side terminals at the time of insertion thereof. When being inserted into the holder 63 of the ink cartridge 100, the apparatus-side terminals 403 to 409, as shown in FIG. 7, slide so as to go over the top face of the circuit board 200 in the direction A2 opposite to the insertion direction. When the ink cartridge 100 is completely installed to the holder 63, the apparatus-side terminals 403 to 409 are brought into contact with approximate center portions of corresponding top-face terminals 203 to 209.

According to the above-described example, the position determining hole 201 is not disposed in the path formed on the circuit board 200 in which the apparatus-side terminals 403 to 409 slide at the time of insertion of the ink cartridge 100 into the holder 63. As a result, the edge of the position determining hole 201 or the first protruded portion PJ1 that perforates the position determining hole 201 is not rubbed with the apparatus-side terminals 403 to 409. Accordingly, the defective contact between the apparatus-side terminals 403 to 409 and the top-face terminals 203 to 209 due to attachment of deposits, which is caused by rubbing, to the apparatus-side terminals 403 to 409 can be suppressed.

In addition, the position determining hole 201 is disposed between the clock terminal 207 and the data terminal 208 for the lower-side row of the top-face terminals. As a result, compared to a case where the position determining hole 201 is disposed on the insertion direction A1 side of the lower-side row, the width of the circuit board 200 in the insertion direction can be decreased. In addition, the position determining hole 201 can be disposed so as to be near all the top-face terminals 203 to 209, and accordingly, the determination precision of the positions of the top-face terminals 203 to 209 is improved. As a result, the reliability of the contact between the apparatus-side terminals 403 to 409 and the top-face terminals 203 to 209 can be improved.

In addition, the position determining hole 201 and the position determining groove 202 are disposed on both ends of the circuit board 200 in the insertion direction A1, and accordingly, the circuit board 200 can be fixed to the ink cartridge 100 in a stable manner. Moreover, since the position determining hole 201 is disposed on the approximate center portion of the width of the circuit board 200 in the direction perpendicular to the insertion direction A1, the circuit board 200 can be fixed to the ink cartridge 100 in a stable manner. In addition, since the position determining hole 201 is disposed in a position between the first rear-face terminal 280 and the second rear-face terminal 290 in which the terminal 244 can be tightly pressed from the rear face, tilt or deviation of the circuit board 200 can be suppressed by the force pressing the terminal from the rear face.

### MODIFIED EXAMPLES

### First Modified Example

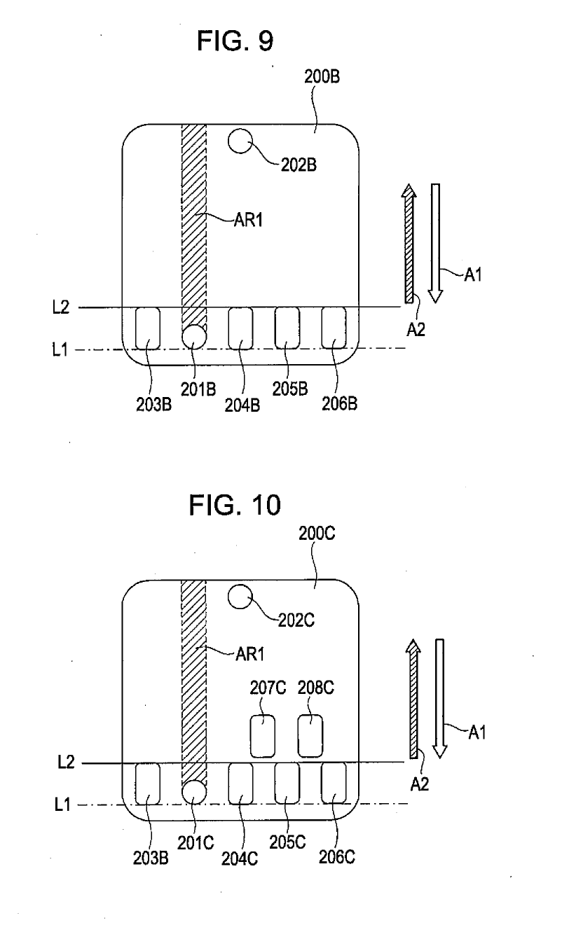

FIG. 9 is a diagram showing the configuration of the top face of a circuit board 200E according to a first modified example. The circuit board 200B according to the first modified example includes four top-face terminals 203B to 206B. As described above, the number of the top-face terminals of the circuit board can be arbitrarily changed in accordance with the specifications of the printer and the ink cartridge. For example, the number of the top-face terminals is not limited to seven as in the above-described example and may be any one of two to six or eight or more.

A position determining hole 201B according to the first modified example is arranged between one terminal 203B and another terminal 204B out of four top-face terminals 203B to 206B. As described above, the position determining hole 201B can be disposed between any arbitrary terminal out of a plurality of the top-face terminals that forms a row in the direction approximately perpendicular to the insertion direction A1 and a terminal that is located adjacently to the terminal.

In addition, the circuit board 200B according to the first modified example has a position determining hole 202B instead of the position determining groove 202 according to the above-described example. As described above, a position determining opening portion may have a groove shape having one side opened to the outer edge or may be a hole shape having an extended edge around the entire circumference.

The position determining hole 201B is arranged on the side of the direction A2 opposite to the insertion direction relative to horizontal line L1 denoted by a dashed-dotted line shown in FIG. 9, that is, the side of the direction A2 opposite to the insertion direction A1 relative to the end portions of the top-face terminals 203B to 206B, which form a row, located on the insertion direction side. In addition, the position determining hole 201B is arranged on the insertion direction A1 side denoted by a solid line L2 shown in FIG. 9, that is, the insertion direction A1 side relative to the end portions of the top-face terminals 203B to 206B, which form a row, located on the side of the direction A2 opposite to the insertion direction.

In the first modified example, as in the above-described example, the top-face terminals are not arranged in the area AR1 through which the position determining hole 201B passes in a case where the position determining hole 201B is assumed to be moved parallel to the side of the direction A2 opposite to the insertion direction. As a result, the same as in the above-described example, the edge of the position determining hole 201B or the first protruded portion that perforates the position determining hole 201B is not rubbed by the apparatus-side terminals. Accordingly, the defective contact between the apparatus-side terminals and the top-face terminals due to attachment of deposits, which is caused by rubbing, to the apparatus-side terminals can be suppressed.

### Second Modified Example

FIG. 10 is a diagram showing the configuration of the top face of a circuit board 200C according to a second modified example. The circuit board 200C according to the second modified example includes top-face terminals 207C and 2080 that form a different row, in addition to the configuration of the circuit board 200B according to the first modified example. Other configurations of the circuit board 200C according to the second modified example are the same as those of the circuit board 200B according to the first modified example. Thus, to each repeated constituent element, a reference sign that is acquired by replacing the prefix “B” of the code assigned as in FIG. 9 with “C” is assigned as in FIG. 10, and a description thereof is omitted here.

The row that is formed by the top-face terminals 2070 and 2080 is arranged on the side of the direction A2 opposite to the insertion direction relative to the row formed by the top-face terminals 203C and 206C. The top-face terminals 207C and 208C are arranged by avoiding an area AR1 through which the position determining hole 2010 passes in a case where the position determining hole 201B is assumed to be moved parallel to the side of the direction A2 opposite to the insertion direction. As a result, the same as in the above-described example, neither the edge of the position determining hole 201C nor the first protruded portion that perforates the position determining hole 201C are rubbed by the apparatus-side terminals. Accordingly, defective contact between the apparatus-side terminals and the top-face terminals due to attachment of depositions, which is caused by rubbing, to the apparatus-side terminals can be suppressed.

### Third Modified Example

In the above-described example and the modified examples, the terminal row of one row or the terminal rows of the two rows are formed on the top face of the circuit board. However, the number of the rows can be arbitrarily changed and may be three or more. In addition, in the above-described example, seven top-face terminals have been described. However, the described function may be arbitrarily changed, and the arranged functions may be changed arbitrarily. In addition, in the above-described example, the number of the rear-face terminals is two. However, the number of the rear-face terminals or the number of rows that are formed by the rear-face terminals may be arbitrarily changed. In the above-described example, the number of the top-face terminals arranged on the circuit board is the same as that of the number of the apparatus-side terminals installed to the printer 20 side. However, as long as the printer 20 can transmit or receive signals to be used, the number of the top-face terminals arranged on the circuit board may be less than or more than the number of the apparatus-side terminals.

### Fourth Modified Example

In the above-described example, an ink cartridge of an atmosphere-opening type in which the atmosphere is introduced into the ink housing portion in accordance with consumption of ink is used. However, the application of the invention is not limited thereto. For example, the invention may be applied to an ink cartridge of a sealing type in which ink is housed in a sealed container and the container is contracted in accordance with the consumption of the ink.

### Fifth Modified Example

In the above example, the ink jet printer and the ink cartridge for the ink jet printer are employed. However, a liquid ejecting apparatus that ejects or injects a liquid other than the ink may be employed. The liquid described here includes a liquid body acquired by dispersing particles of a functional material into solvent or a fluid body such as a gel body. As examples of such liquid ejecting apparatuses, there are: a liquid ejecting apparatus that ejects a liquid that contains a material such as an electrode material or a coloring material in a dispersed form or dissolved form that is used for manufacturing a liquid crystal display, an EL (electroluminescence) display, or a field emission display, a color filter, or the like; a liquid ejecting apparatus that ejects a bioorganic material that is used for manufacturing a bio chip; and a liquid ejecting apparatus that is used as a precision pipette and ejects a liquid that becomes a test material. In addition, the invention may be applied to: a liquid ejecting apparatus that ejects a lubricant to a precision machine such as a clock or a camera in a pin-point manner; a liquid ejecting apparatus that ejects a transparent resin liquid such as an ultraviolet-curable resin onto a board for forming a tiny hemispherical lens (optical lens) used in an optical communication element or the like; and a liquid ejecting apparatus that ejects an acid etching solution, alkali etching solution, or the like for etching a board or the like. Furthermore, the invention may be applied to any one of the above-described apparatuses as well as a liquid container that is installed to the ejecting apparatus.

### Sixth Modified Example

In the above-described example, the piezoelectric element is used as a sensor. However, a sensor of another type may be used. For example, a sensor of the type in which the value of resistance of ink is measured by allowing a current to flow in the ink may be used. In addition, the sensor is not limited to a sensor that detects the remaining amount of ink. Thus, a sensor that electrically detects the viscosity, the type, the density, or the like of the ink may be used. Generally speaking, a sensor that electrically detects the liquid state of the ink or the like may be used.

### Seventh Modified Example

In the above-described example, the top-face terminals that are used for electrically connecting the sensor and the memory device that are included in the ink cartridge and the printer together are arranged on the circuit board. However, the electric devices included in the ink cartridge are not limited to the sensor and the memory device and may be changed to various forms. For example, instead of the above-described sensor and the memory device, a processor such as a CPU or an ASIC that exchanges information with the printer or a simple IC may be used. In addition, the invention may be applied to an ink cartridge of the type in which a sensor or the like is not mounted and only a memory device is mounted.

### Eighth Modified Example

In the above-described example, one ink tank is configured as one ink cartridge. However, a plurality of ink tanks may be configured as one ink cartridge.

### Ninth Modified Example

In the above-described example, the liquid supplying unit is an ink cartridge having a circuit board fixed to the container main body, and the circuit board is installed to the holder, which is installed to the print head unit, integrally with the container main body. However, as a liquid supplying unit to which the invention is applied, an ink cartridge in which a cover, to which the circuit board is fixed, and the container main body housing the liquid are individually installed to the holder may be used. For example, a configuration may be used in which a cover, to which the circuit board is fixed, is inserted in a holder in a predetermined insertion direction, and then the container main body is installed to the holder.

### Tenth Modified Example

In the above-described example, the liquid housing unit is installed to the holder of the print head unit, and ink is directly supplied from the ink supplying portion to the print head. However, a configuration in which the liquid housing unit is installed to a position located far from the head of the liquid ejecting apparatus, and ink is supplied to the head though a tube that is connected to the liquid supplying portion of the liquid housing unit may be used.

The example and the modified examples of the invention have been described above. However, the above-described embodiments are not for the purpose of limiting the invention but for the purpose of facilitating understanding of the invention. The invention may be changed or modified without departing from the basic idea of the invention or the scope of claims. In addition, equivalents of the invention come within the scope of the invention.

The entire disclosure of Japanese Patent Application Nos. 2008-262640, filed Oct. 9, 2008 and 2009-199165, filed Aug. 31, 2009 are expressly incorporated by reference herein.

What is claimed is:

1. A circuit board that is fixed to a liquid supplying unit installed to a liquid ejecting apparatus by being inserted into the liquid ejecting apparatus having a plurality of first apparatus-side terminals in a predetermined insertion direction, the circuit board comprising:
a board main body that includes a first opening portion that is used for determining the position of the circuit board with respect to the liquid supplying unit; and
a plurality of first top-face terminals, disposed on a first face of the board main body, that is brought into contact with at least a part of the plurality of first apparatus-side terminals and is arranged in the direction approximately perpendicular to the insertion direction when being installed to the liquid ejecting apparatus,
wherein the first opening portion is disposed on the rear side relative to the front ends of the plurality of first top-face terminals in the insertion direction and is disposed between a first terminal and a second terminal out of the plurality of first top-face terminals.

2. The circuit board according to claim 1,
wherein the liquid ejecting apparatus further includes: a second top-face terminal, disposed on the first face of the board main body, that is brought into contact with a second apparatus-side terminal when being installed to the liquid ejecting apparatus,
wherein the liquid ejecting apparatus further includes the second apparatus-side terminal that is disposed in a position different from those of the plurality of first apparatus-side terminals in the insertion direction, and
wherein the second top-face terminal is disposed in an area other than an area through which the first opening portion passes in a case where the first opening portion is assumed to be moved parallel in a direction opposite to the insertion direction.

3. The circuit board according to claim 1, wherein the first opening portion is disposed between the front ends and the rear ends of the plurality of first top-face terminals in the insertion direction.

4. The circuit board according to claim 1,
wherein the board main body further includes a second opening portion that is used for determining the position of the circuit board with respect to the liquid supplying unit, and
wherein the second opening portion is disposed on the rear side relative to the rear ends of the plurality of top-face terminals in the insertion direction.

5. The circuit board according to claim 1, wherein the first terminal and the second terminal are the two terminals, which are closest to the center of the width of the circuit board in the direction perpendicular to the insertion direction, out of the plurality of first top-face terminals.

6. The circuit board according to claim 1, further comprising: a first rear-face terminal and a second rear-face terminal that are disposed on the second face of the board main body and are electrically connected to a plurality of unit terminals included in the liquid supplying unit,
wherein the first opening portion is disposed between the first rear-face terminal and the second rear-face terminal.

7. A circuit board that is fixed to a liquid supplying unit installed to a liquid ejecting apparatus by being inserted into the liquid ejecting apparatus having a plurality of apparatus-side terminals in a predetermined insertion direction, the circuit board comprising:
a board main body that includes a first opening portion that is used for determining the position of the circuit board with respect to the liquid supplying unit; and
a plurality of top-face terminals, disposed on a first face of the board main body, that is brought into contact with at least a part of the plurality of apparatus-side terminals when being installed to the liquid ejecting apparatus,
wherein the first opening portion is disposed on the insertion direction side relative to the rear ends of the plurality of top-face terminals in the insertion direction and is disposed in an area other than an area through which the plurality of top-face terminals passes in a case where the plurality of top-face terminals is assumed to be moved parallel in the insertion direction.

8. A circuit board that is fixed to a liquid supplying unit installed to a liquid ejecting apparatus by being inserted into the liquid ejecting apparatus having a plurality of apparatus-side terminals in a predetermined insertion direction, the circuit board comprising:
a board main body that includes a first opening portion that is used for determining the position of the circuit board with respect to the liquid supplying unit; and
a plurality of top-face terminals, disposed on a first face of the board main body, that is brought into contact with at least a part of the plurality of apparatus-side terminals when being installed to the liquid ejecting apparatus,
wherein, the pitches of adjacent apparatus-side terminals, out of the plurality of apparatus-side terminals, measured in the direction perpendicular to the insertion direction include a first pitch and a second pitch that is wider than the first pitch, and
wherein the first opening portion is disposed between two straight lines that are acquired by extending the loci of two of the apparatus-side terminals disposed at the second pitch on the board main body when the board main body is installed to the liquid ejecting apparatus.

9. The circuit board according to claim 8, wherein the second pitch is a pitch that is N times the first pitch (where N is an integer equal to or larger than two).

10. A liquid supplying unit comprising: a circuit board according to claim 1.
